(19) United States
(12) Patent Application Publication
(10) Pub. No.: US 2026/0330386 A1
(43) Pub. Date: Oct. 22, 2026

(54) SYSTEMS, APPARATUSES, METHODS, AND COMPUTER PROGRAM PRODUCTS FOR A PROJECT OUTCOME PREDICTIVE ENGINE

(71) Applicant: Honeywell International Inc., Charlotte, NC (US)

(72) Inventors: Anil PALLAYIL, Charlotte, NC (US); Rahul SHARMA, Houston, TX (US); Honey RAGHAVAN, Bangalore (IN)

(21) Appl. No.: 19/651,408

(22) Filed: Apr. 17, 2026

Related U.S. Application Data
(60) Provisional application No. 63/790,873, filed on Apr. 18, 2025.

(51) Int. Cl. G06Q 10/0637; G06N 5/02

(52) U.S. Cl. CPC G06Q 10/06375; G06N 5/027

(57) ABSTRACT

Systems, apparatuses, methods, and computer program products are provided herein. A method may include receiving project information comprising high-level project data and descriptive project data associated with a subject project. The method comprises identifying a first set of similar historical projects based on the high-level project data. The method comprises determining, using a trained prediction model, a preliminary success-rate prediction based on the first set of similar historical projects. The method comprises generating a project proposal. The method comprises identifying a second set of similar historical projects based on the descriptive project data and the project proposal. The method comprises determining, using the trained prediction model updated based on the second set of similar historical projects, an updated success-rate prediction. The method comprises generating a proposal item update to improve the updated success-rate prediction. The method comprises generating an updated proposal according to the proposal item update.

### CROSS-REFERENCE TO RELATED APPLICATIONS

This application claims priority and benefit to U.S. Provisional Patent Application No. 63/790,873, filed Apr. 18, 2025, the contents of which are incorporated herein by reference in its entirety.

### TECHNOLOGICAL FIELD

Embodiments of the present disclosure relate generally to systems, apparatuses, methods, and computer program products for a project outcome predictive engine.

### BACKGROUND

Applicant has identified many technical challenges and difficulties associated with systems, apparatuses, methods, and computer program products for a project outcome predictive engine. Through applied effort, ingenuity, and innovation, Applicant has solved problems related to systems, apparatuses, methods, and computer program products for a project outcome predictive engine by developing solutions embodied in the present disclosure, which are described in detail below.

### BRIEF SUMMARY

Various embodiments described herein relate to systems, apparatuses, methods, and computer program products for a project outcome predictive engine.

In accordance with one aspect of the disclosure a method is provided. In some embodiments, the method comprises receiving, by one or more processors, a set of project information comprising high-level project data and descriptive project data associated with a subject project. In some embodiments, the method comprises identifying, by the one or more processors, a first set of similar historical projects based on the high-level project data. In some embodiments, the method comprises determining, by the one or more processors and using a trained prediction model, a preliminary success-rate prediction based on analysis of the first set of similar historical projects. In some embodiments, the method comprises generating, by the one or more processors, a project proposal responsive to determining that the preliminary success-rate meets or exceeds a defined threshold. In some embodiments, the method comprises identifying, by the one or more processors, a second set of similar historical projects based on the descriptive project data and the project proposal. In some embodiments, the method comprises determining, by the one or more processors and using the trained prediction model updated based on the second set of similar historical projects, an updated success-rate prediction. In some embodiments, the method comprises generating, by the one or more processors, at least one proposal item update to improve the updated success-rate prediction. In some embodiments, the method comprises generating, by the one or more processors, an updated proposal according to the at least one proposal item update.

In accordance with some aspects of the disclosure, the method further comprises generating, by the one or more processors, a customizable similarity profile configured to define one or more metrics according to which the first set of similar historical projects or the second set of similar historical projects are determined.

In accordance with some aspects of the disclosure, the customizable similarity profile defines one or more feature weights corresponding to one or more features, wherein the first set of similar historical projects or the second set of historical projects are determined according to the one or more feature weights.

In accordance with some aspects of the disclosure, the customizable similarity profile defines a first priority feature of the one or more features according to which the first set of similar historical projects are determined.

In accordance with some aspects of the disclosure, the method further comprises determining, by the one or more processors, a success-rate correlation between a first feature of the one or more features and a subset of winning projects of the first set of similar historical projects.

In accordance with some aspects of the disclosure, the method further comprises determining, by the one or more processors, a success-rate delta for a subject feature of the one or more features between a percentage of successful proposals which exhibit the subject feature and a percentage of losing proposals which exhibit the subject feature.

In accordance with some aspects of the disclosure, the method further comprises flagging, by the one or more processors, the subject feature as a success-correlated feature responsive to determining that the success-rate delta exceeds a defined threshold.

In accordance with some aspects of the disclosure, the method further comprises determining, by the one or more processors, a project limitation impact associated with the at least one proposal item update, generating, by the one or more processors, a substitute proposal item update to improve the updated success-rate prediction responsive to determining the project limitation impact exceeds an acceptable threshold.

In accordance with another aspect of the disclosure, an apparatus is provided. In some embodiments, the apparatus includes memory and one or more processors communicatively coupled to the memory. In some embodiments, the one or more processors are configured to perform operations comprising receiving a set of project information comprising high-level project data and descriptive project data associated with a subject project. In some embodiments the one or more processors are configured to perform operations comprising identifying a first set of similar historical projects based on the high-level project data. In some embodiments, the one or more processors are configured to perform operations comprising determining, using a trained prediction model, a preliminary success-rate prediction based on analysis of the first set of similar historical projects. In some embodiments, the one or more processors are configured to perform operations comprising generating a project proposal responsive to determining that the preliminary success-rate meets or exceeds a defined threshold. In some embodiments, the one or more processors are configured to perform operations comprising identifying a second set of similar historical projects based on the descriptive project data and the project proposal. In some embodiments, the one or more processors are configured to perform operations comprising determining, using the trained prediction model updated based on the second set of similar historical projects, an updated success-rate prediction. In some embodiments, the one or more processors are configured to perform operations comprising generating at least one proposal item update to improve the updated success-rate prediction. In some embodiments, the one or more processors are configured to perform operations comprising generating an updated proposal according to the at least one proposal item update.

In accordance with some aspects of the disclosure, the one or more processors are configured to perform operations comprising generating a customizable similarity profile configured to define one or more metrics according to which the first set of similar historical projects or the second set of similar historical projects are determined.

In accordance with some aspects of the disclosure, the customizable similarity profile defines one or more feature weights corresponding to one or more features, wherein the first set of similar historical projects or the second set of historical projects are determined according to the one or more feature weights.

In accordance with some aspects of the disclosure, the customizable similarity profile defines a first priority feature of the one or more features according to which the first set of similar historical projects are determined.

In accordance with some aspects of the disclosure, the one or more processors are configured to perform operations comprising determining a success-rate correlation between a first feature of the one or more features and a subset of winning projects of the first set of similar historical projects.

In accordance with some aspects of the disclosure the one or more processors are configured to perform operations comprising determining a success-rate delta for a subject feature of the one or more features between a percentage of successful proposals which exhibit the subject feature and a percentage of losing proposals which exhibit the subject feature.

In accordance with some aspects of the disclosure, the one or more processors are configured to perform operations comprising flagging the subject feature as a success-correlated feature responsive to determining that the success-rate delta exceeds a defined threshold.

In accordance with some aspects of the disclosure, the one or more processors are configured to perform operations comprising determining a project limitation impact associated with the at least one proposal item update, generating a substitute proposal item update to improve the updated success-rate prediction responsive to determining the project limitation impact exceeds an acceptable threshold.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving a set of project information comprising high-level project data and descriptive project data associated with a subject project. In some embodiments, the computer program code, in execution with at least one processor, configures the computer program product for identifying a first set of similar historical projects based on the high-level project data. In some embodiments, the computer program code, in execution with at least one processor, configures the computer program product for determining, using a trained prediction model, a preliminary success-rate prediction based on analysis of the first set of similar historical projects. In some embodiments, the computer program code, in execution with at least one processor, configures the computer program product for generating a project proposal responsive to determining that the preliminary success-rate meets or exceeds a defined threshold. In some embodiments, the computer program code, in execution with at least one processor, configures the computer program product for identifying a second set of similar historical projects based on the descriptive project data and the project proposal. In some embodiments, the computer program code, in execution with at least one processor, configures the computer program product for determining, using the trained prediction model updated based on the second set of similar historical projects, an updated success-rate prediction. In some embodiments, the computer program code, in execution with at least one processor, configures the computer program product for generating at least one proposal item update to improve the updated success-rate prediction. In some embodiments, the computer program code, in execution with at least one processor, configures the computer program product for generating an updated proposal according to the at least one proposal item update.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure;

FIG. 4 illustrates an example machine learning framework in accordance with one or more embodiments of the present disclosure.

FIG. 5 illustrates an example project outcome predictive engine in accordance with one or more embodiments of the present disclosure.

FIG. 6 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for a project outcome predictive engine. As would be understood by one skilled in the field to which this disclosure pertains, there are numerous example scenarios in which systems, apparatuses, methods, and computer program products for a project outcome predictive engine.

Generating a proposal to complete a project can be a costly and time consuming exercise and can ultimately be wasteful in instances where a project is a “bad fit” for a vendor, for example. Existing success rate analysis systems fail to provide a two-stage success-rate prediction methodology by which a project is subjected to an initial success-rate prediction based on high-level project information before resources are committed to developing a proposal, and subsequently generating a proposal and determining an updated success-rate prediction based on the developed proposal. Embodiments of the present disclosure provide improved success-rate prediction associated with a project by providing success rate insights before resources are committed to developing a full proposal.

Thus, to address these and/or other issues related to such example solutions, example systems, apparatuses, methods, and computer program products for a project outcome predictive engine are disclosed herein. For example, a method disclosed herein comprises receiving, by one or more processors, a set of project information comprising high-level project data and descriptive project data associated with a subject project. In some embodiments, the method comprises identifying, by the one or more processors, a first set of similar historical projects based on the high-level project data. In some embodiments, the method comprises determining, by the one or more processors and using a trained prediction model, a preliminary success-rate prediction based on analysis of the first set of similar historical projects. In some embodiments, the method comprises generating, by the one or more processors, a project proposal responsive to determining that the preliminary success-rate prediction meets or exceeds a defined threshold. In some embodiments, the method comprises identifying, by the one or more processors, a second set of similar historical projects based on the descriptive project data and the project proposal. In some embodiments, the method comprises determining, by the one or more processors and using the trained prediction model updated based on the second set of similar historical projects, an updated success-rate prediction. In some embodiments, the method comprises generating, by the one or more processors, at least one proposal item update to improve the updated success-rate prediction. In some embodiments, the method comprises generating, by the one or more processors, an updated proposal according to the at least one proposal item update.

Further embodiments and advantages of the example systems, apparatuses, methods, and computer program products disclosed herein are described in the following co-pending U.S. patent applications: U.S. Application No. 63/790,876, titled “SYSTEMS, APPARATUSES, METHODS, AND COMPUTER PROGRAM PRODUCTS FOR AN INTERACTIVE PROJECT REQUIREMENTS ANALYSIS ENGINE”; U.S. Application No. 63/790,880, titled “SYSTEMS, APPARATUSES, METHODS, AND COMPUTER PROGRAM PRODUCTS FOR AUTOMATED PROJECT OPERATIONS ARCHITECTURE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,882, titled “SYSTEMS, APPARATUSES, METHODS, AND COMPUTER PROGRAM PRODUCTS FOR REAL-TIME PROJECT INVENTORY OPTIMIZATION”; U.S. Application No. 63/790,885, titled “SYSTEMS, APPARATUSES, METHODS, AND COMPUTER PROGRAM PRODUCTS FOR REAL-TIME PROJECT SERVICES OPERATIONS”; U.S. Application No. 63/790,889, titled “SYSTEMS, APPARATUSES, METHODS, AND COMPUTER PROGRAM PRODUCTS FOR PROJECT PROGRAM GENERATION”; U.S. Application No. 63/790,892, titled “SYSTEMS, APPARATUSES, METHODS, AND COMPUTER PROGRAM PRODUCTS FOR AUTOMATED PROJECT QUALITY CONTROL”; U.S. Application No. 63/790,879, titled “SYSTEMS, APPARATUSES, METHODS, AND COMPUTER PROGRAM PRODUCTS FOR AI DRIVEN PROJECT COMPLIANCE FORECASTING”, each of which is filed concurrently with the present application. The contents of each of the foregoing applications are hereby incorporated by reference in their entirety.

### Example Systems and Apparatuses

Embodiments of the present disclosure herein include systems, apparatuses, methods, and computer program products configured for project outcome prediction. It should be readily appreciated that the embodiments of the apparatus, systems, methods, and computer program product described herein may be configured in various additional and alternative manners in addition to those expressly described herein.

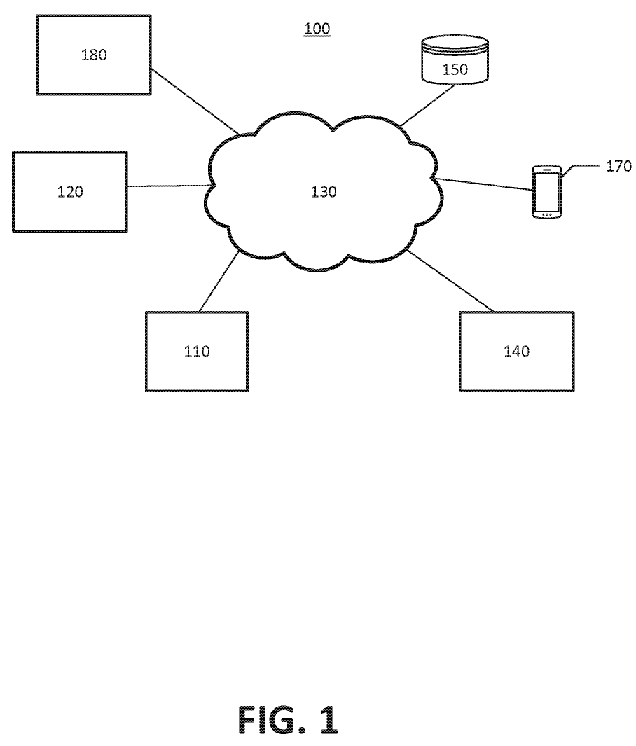

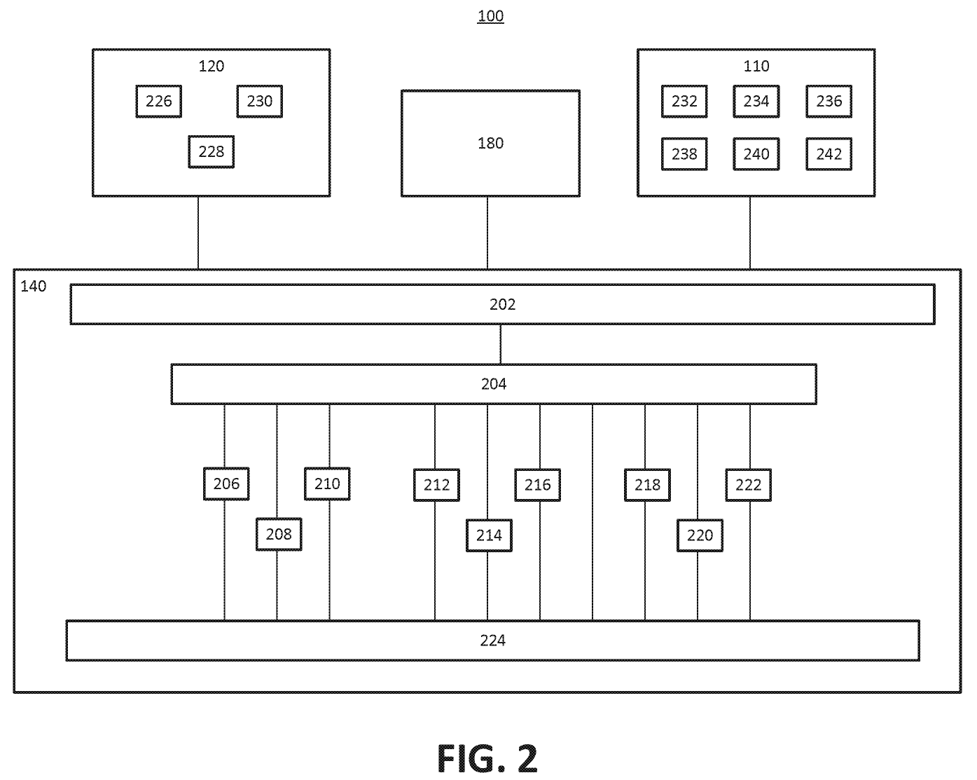

FIGS. 1 and 2 illustrate exemplary block diagrams of an environment 100 in which embodiments of the present disclosure may operate. In some embodiments, the environment 100 comprises a cloud-based project operations device 140. In some embodiments, the cloud-based project operations device 140 is electronically and/or communicatively coupled to a project foundation device 180, an external project implementation device 120, an external project application device 110, one or more databases 150, and/or the user device 170. The cloud-based project operations device 140 may be located remotely from the project foundation device 180, the external project implementation device 120, the external project application device 110, the one or more databases 150, and/or the user device 170. In this regard, for example, the cloud-based project operations device 140 may be located in a remote cloud server and electronically and/or communicatively coupled to the project foundation device 180, the external project implementation device 120, the external project application device 110, the one or more databases 150, and/or the user device 170 via at least the network 130. In some embodiments, the cloud-based project operations device 140 is configured via hardware, software, firmware, and/or a combination thereof, to perform data intake of one or more types of data.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the cloud-based project operations device 140 comprises a project operations security layer 202 configured to execute and/or perform one or more operations and/or functions described herein. For example, the project operations security layer 202 may be configured to control access permissions for the cloud-based project operations device 140. In some embodiments, the cloud-based project operations device 140 comprises a project orchestration predictive computing entity 204 configured to execute and/or perform one or more operations and/or functions described herein. In some embodiments, the cloud-based project operations device 140 comprises one or more internal predictive computing entities configured to execute and/or perform one or more operations and/or functions described herein. For example, the cloud-based project operations device 140 may comprise an inventory predictive computing entity 206, a program predictive computing entity 208, a project condition predictive computing entity 210, a project record predictive computing entity 212, a project component engineering predictive computing entity 214, a project command predictive computing entity 216, a project prompt predictive computing entity 218, a project operations predictive computing entity 220, a project services predictive computing entity 222, and/or the like. In some embodiments, the cloud-based project operations device 140 comprises an internal database 224 configured to execute and/or perform one or more operations and/or functions described herein. For example, the internal database 224 may be a vectorized database.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the external project implementation device 120 comprises one or more external predictive computing entities configured to execute and/or perform one or more operations and/or functions described herein. For example, the external project implementation device 120 may comprise a project extraction predictive computing entity 226, a project code predictive computing entity 228, a project bot predictive computing entity 230, and/or the like.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the external project application device 110 comprises one or more external computing applications configured to execute and/or perform one or more operations and/or functions described herein. For example, THE external project application device 110 may comprise a project operations computing application 232, a project impact value computing application 234, a project documentation computing application 236, a project component computing application 238, a project generation computing application 240, a project automation computing application 242, and/or the like.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

Additionally, while FIGS. 1 and 2 illustrate certain components as separate, standalone entities communicating over the network 130, various embodiments are not limited to this configuration. In other embodiments, one or more components may be directly connected and/or share hardware or the like.

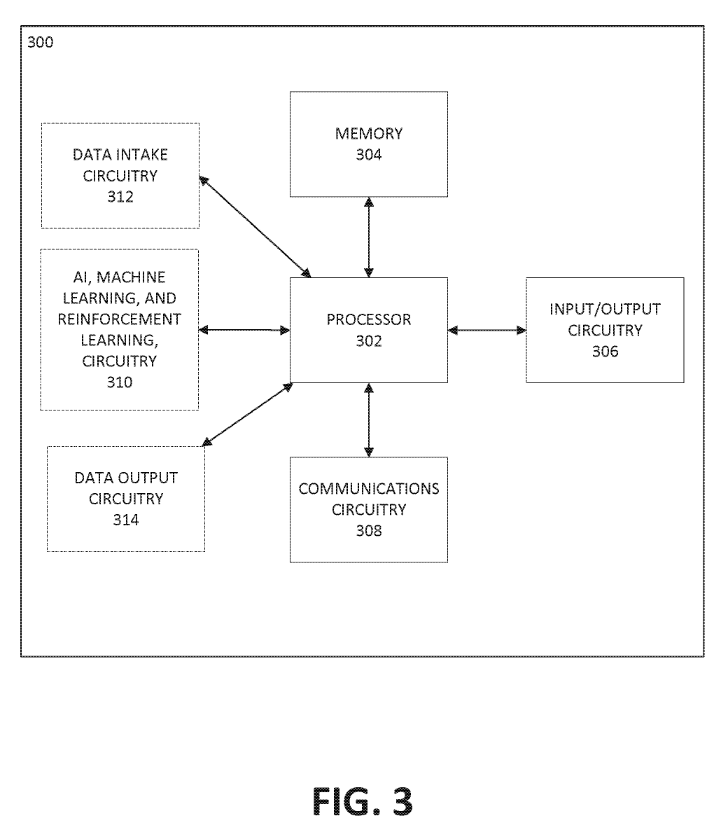

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

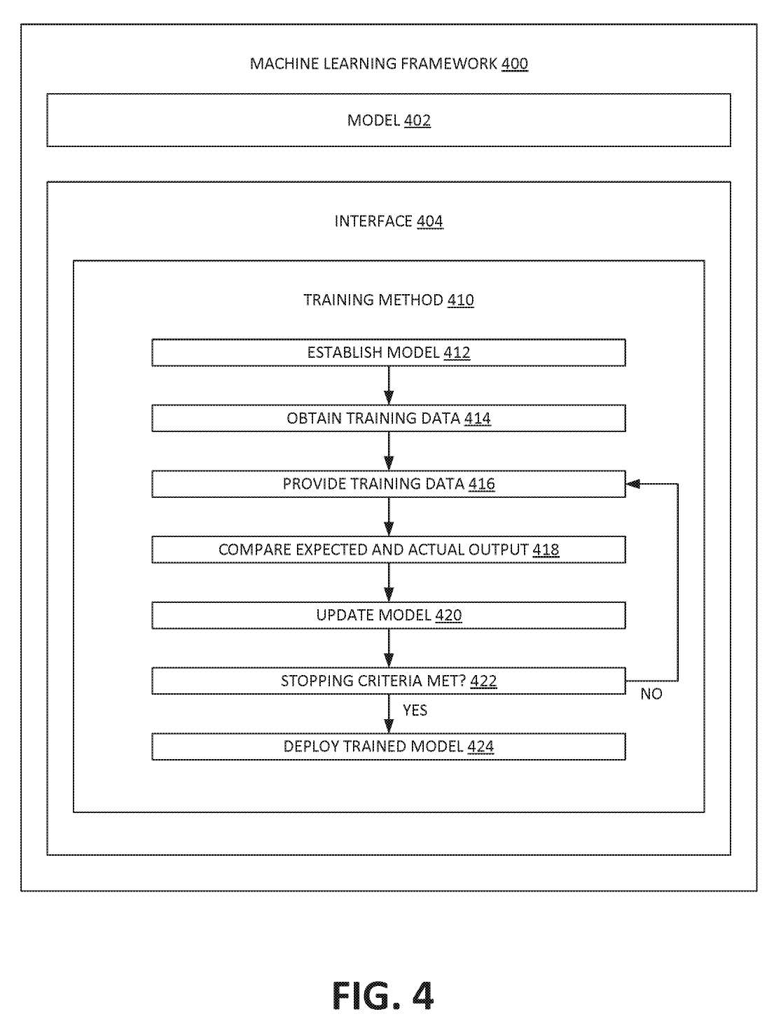

FIG. 4 illustrates an example machine learning framework 400 that techniques described herein may benefit from or improve on. A machine learning framework 400 is a collection of software and data that implements artificial intelligence trained to provide output, such as predictive data, based on input. Examples of artificial intelligence that can be implemented with machine learning way include neural networks (including recurrent neural networks), language models (including so-called “large language models”), generative models, natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 400 or components thereof are often built or refined from existing frameworks, such as TENSORFLOW by GOOGLE, INC. or PYTORCH by the PYTORCH community. The machine learning frameworks 400 may correspond to techniques as leveraged by the various data processors as described herein for various data processing functions.

The machine learning framework 400 can include one or more models 402 that are the structured representation of learning and an interface 404 that supports use of the model 402. The model 402 may include can take any of a variety of forms. In many examples, the model 402 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 402 can include a representation of memory (e.g., providing long short-term memory functionality). Where the set includes more than one model 402, the models 402 can be linked, cooperate, or compete to provide output.

The interface 404 can include software procedures (e.g., defined in a library) that facilitate the use of the model 402, such as by providing a way to establish and interact with the model 402. For instance, the software procedures can include software for receiving input, preparing input for use (e.g., by performing vector embedding, such as using Word2Vec, BERT, or another technique), processing the input with the model 402, providing output, training the model 402, performing inference with the model 402, fine tuning the model 402, other procedures, or combinations thereof.

In an example implementation, interface 404 can be used to facilitate a training method 410. The training method 410 may therefore include or be used to implement operation 224 of FIG. 2. The training method 410 may include operation 412, which includes establishing a model 402, such as initializing a model 402. The establishing can include setting up the model 402 for further use (e.g., by training or fine tuning). The model 402 can be initialized with values. In examples, the model 402 can be pretrained.

Operation 414 can follow operation 412. Operation 414 includes obtaining training data; in many examples, the training data includes pairs of input (e.g., training sequence data objects and respective contextual data objects) and desired output (e.g., labels) given the input. In supervised or semi-supervised training, the data can be prelabeled, such as by human or automated labelers. In unsupervised learning the training data can be unlabeled.

Many examples herein are related to supervised prediction of disruptions to pinpoint the weights or importance of events. But certain embodiments may operate without explicit labels but with implicit labels computed based on other data. Thus, data need not be explicitly labeled. But it can be beneficial to use an input labeler to infer labels and to train a supervised model.

The training data can include validation data used to validate the trained model 402. Operation 416 can follow operation 414. Operation 416 includes providing a portion of the training data to the model 402. This can include providing the training data in a format usable by the model 402. The machine learning framework 400 (e.g., via the interface 404) can cause the model 402 to produce an output based on the input.

Operation 418 can follow operation 416. Operation 418 includes comparing the expected output with the actual output. In an example, this can include applying a loss function to determine the difference between expected and actual data. This value can be used to determine how training is progressing. Operation 420 can follow operation 418. Operation 420 includes updating the model 402 based on the result of the comparison. This can take any of a variety of forms depending on the nature of the model 402. Where the model 402 includes weights, the weights can be modified to increase the likelihood that the model 402 will produce correct output given an input. Depending on the model 402, backpropagation or other techniques can be used to update the model 402.

Operation 422 can follow operation 420. Operation 422 includes determining whether a stopping criterion has been reached, such as based on the output of the loss function (e.g., actual value or change in value over time). In addition, or instead, whether the stopping criterion has been reached can be determined based on a number of training epochs that have occurred or an amount of training data that has been used. In some examples, satisfaction of the stopping criterion can include if the stopping criterion has not been satisfied, the flow of the method can return to operation 414. If the stopping criterion has been satisfied, the flow can move to operation 422.

Operation 424 includes deploying the trained model 402 for use in production, such as providing the trained model 402 with real-world input data and produce output data used in a real-world process. The model 402 can be stored in memory of at least one computer or distributed across memories of two or more such computers for production of output data.

The use of a computer and network implemented system in generating outputs, and associated electronic communications, enables leveraging of machine learning processes, neural networks, and attention mechanisms to efficiently extract meaningful outputs from large datasets, by embedding respective contextual data in the attention mechanism along with respective sequence data objects. Accordingly, example embodiments provide improvements over systems that merely process input sequences, or sequence data objects, without context. The improvements may be realized with input data that spans long timeframes of multiple sequence events. The generated outputs are also more accurate and are able to detect latent and hidden relationships between multiple sequenced events.

Example embodiments may simultaneously consider multiple types of contextual data objects (e.g., subsequence contexts, token-level contexts, and token-to-token contexts). Example embodiments, learn, understand, and predict latent pattern of data not only considering the sequence data object, such as transactional data, but further contextualize each sequence within its context – including any known subsequence contexts, token-level contexts, and token-to-token contexts. Example embodiments further leverage the attention mechanism to provide an importance scoring or weighting of the features within an input sequence as well as in the contextual data.

Additionally, example embodiments may create one model across all subjects and entities, to make generalization across users, demographics, or other groupings of people or entire populations. Example embodiments may therefore generate a foundational model that directly enables various downstream application and tasks.

By sharing model parameters and applying transfer learning techniques across customers, example embodiments can leverage the knowledge gained from one customer's transactional data to improve the forecasting for another. This transfer of learning allows the model to generalize across customers and capture common patterns and trends, resulting in more accurate predictions.

With reference to FIGS. 1-6, in some embodiments, a project may be a collection of components that may be implemented in a configured manner to accomplish one or more tasks. In this regard, for example, a project may be a collection of components that may be implemented in a configured manner in order to control the temperature of a building. For example, a project may be a collection of configured components that include temperature sensors, temperature control systems, circuits, and/or heating, ventilation, and air conditioning (HVAC) units that may be implemented in order to control the temperature of a building.

In some embodiments, the cloud-based project operations device 140 is configured to access one or more requirement electronic records. For example, the cloud-based project operations device 140 may be configured to access one or more requirement electronic records at the project orchestration predictive computing entity 204 (e.g., the cloud-based project operations device 140 is configured to access one or more requirement electronic records using the project orchestration predictive computing entity 204).

In some embodiments, a requirement electronic record comprises an electronic record that is representative of one or more requirement features (e.g., a requirement electronic record comprises one or more electronic records). In this regard, in some embodiments, a requirement electronic record may be one or more of a text document, a schematic drawing, a 3D model, a computer-aided design (CAD) file, an image, a video, and/or the like. For example, a requirement electronic record may be a schematic drawing that depicts one or more requirement features. As another example, a requirement electronic record may be a video that depicts one or more requirement features. As another example, a requirement electronic record may be a text document that describes one or more requirement features. As another example, a requirement electronic record may be a 3D model that depicts one or more requirement features. As another example, requirement electronic record may be a computer-aided design (CAD) file that describes and/or depicts one or more requirement features. As another example, requirement electronic record may be an image that depicts one or more requirement features.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, requirement feature may be representative of a physical layout of a building in which the temperature is to be controlled (e.g., a constraint).

In some embodiments, accessing one or more requirement electronic records comprises the cloud-based project operations device 140 being configured to retrieve one or more requirement electronic records. For example, the cloud-based project operations device 140 may be configured to retrieve one or more requirement electronic records from the one or more databases 150 using the project orchestration predictive computing entity 204. As another example, the cloud-based project operations device 140 may be configured to retrieve one or more requirement electronic records from the internal databases 224 using the project orchestration predictive computing entity 204. In some embodiments, accessing one or more requirement electronic records comprises the cloud-based project operations device 140 being configured to receive one or more requirement electronic records. For example, the cloud-based project operations device 140 may be configured to receive one or more requirement electronic records from the project foundation device 180. In some embodiments, prior to the cloud-based project operations device 140 accessing one or more requirement electronic records at the project orchestration predictive computing entity 204, at least one of the one or more requirement electronic records may be processed by the project operations security layer 202 using one or more cybersecurity operations.

In some embodiments, the cloud-based project operations device 140 is configured to identify an archived project electronic record. In some embodiments, an archived project electronic record comprises an electronic record that describes a completed, previous, and/or archived project. In this regard, in some embodiments, an archived project electronic record is representative of a collection of archived project components that were implemented in the completed, previous, and/or archived project associated with the archived project electronic record. For example, an archived project electronic record may be representative of a collection of archived project components that include temperature sensors, temperature control systems, circuits, and/or heating, ventilation, and air conditioning (HVAC) units that have been configured to control the temperature of a building. Said differently, for example, an archived project electronic record may be representative of an archived project component that formed a portion of a completed, previous, and/or archived project.

In some embodiments, the cloud-based project operations device 140 is configured to identify an archived project electronic record using the project record predictive computing entity 212. In some embodiments, the cloud-based project operations device 140, using the project record predictive computing entity 212, is configured to identify an archived project electronic record by performing at least one electronic filtering operation of a set of electronic filtering operations. In some embodiments, the cloud-based project operations device 140, using the project record predictive computing entity 212, is configured to identify an archived project electronic record based on a requirement electronic record. In this regard, in some embodiments, the cloud-based project operations device 140, using the project record predictive computing entity 212, is configured to perform one or more of the set of electronic filtering operations based on a requirement electronic record.

In some embodiments, the set of electronic filtering operations comprises a text-based filtering operation. In some embodiments, a text-based filtering operation comprises identifying a first sequence of characters from a requirement electronic record using an optical character recognition (OCR) technique. In some embodiments, a text-based filtering operation comprises identifying one or more other sequences of characters from one or more archived project electronic records using an optical character recognition (OCR) technique. In some embodiments, a text-based filtering operation comprises comparing the first sequence of characters with one or more of the one or more other sequences of characters. In this regard, for example, the cloud-based project operations device 140 may identify an archived project electronic record by finding a match between the first sequence of characters and the one or more of the one or more other sequences of characters. In some embodiments, the cloud-based project operations device 140 may leverage the project extraction predictive computing entity 226 to execute an optical character recognition (OCR) technique (e.g., the project extraction predictive computing entity 226 may be configured to perform an optical character recognition (OCR) technique).

In some embodiments, the set of electronic filtering operations comprises a geometry-based filtering operation. In some embodiments, a geometry-based filtering operation comprises identifying a geometric element from a requirement electronic record. In some embodiments, a geometry-based filtering operation comprises identifying one or more other geometric elements from one or more archived project electronic records. In some embodiments, a geometry-based filtering operation comprises comparing the geometric element with one or more of the one or more other geometric elements. In this regard, for example, the cloud-based project operations device 140 may identify an archived project electronic record by finding a match between the geometric element and the one or more of the one or more other geometric elements.

In some embodiments, the set of electronic filtering operations comprises a design-based filtering operation. In some embodiments, a design-based filtering operation comprises identifying a data encoding from a requirement electronic record. For example, a data encoding may comprise one or more of an svg, .dwg, .tiff, .png, .obj, .amf, .stl, and/or .glb data encoding. In some embodiments, a design-based filtering operation comprises identifying one or more other data encodings from one or more archived project electronic records. In some embodiments, a design-based filtering operation comprises comparing the data encoding with one or more of the one or more other data encodings. In this regard, for example, the cloud-based project operations device 140 may identify an archived project electronic record by finding a match between the data encoding and the one or more of the one or more other data encodings.

In some embodiments, the set of electronic filtering operations comprises a sketch-based filtering operation. In some embodiments, a sketch-based filtering operation comprises identifying a sketch feature from a requirement electronic record. For example, a sketch feature may be representative of a feature of a sketch or 3D model. In some embodiments, a sketch-based filtering operation comprises identifying one or more other sketch features from one or more archived project electronic records. In some embodiments, a sketch-based filtering operation comprises comparing the sketch feature with one or more of the one or more other sketch features. In this regard, for example, the cloud-based project operations device 140 may identify an archived project electronic record by finding a match between the sketch feature and the one or more of the one or more other sketch features.

In some embodiments, the set of electronic filtering operations comprises a topology-based filtering operation. In some embodiments, a topology-based filtering operation comprises identifying a topology feature from a requirement electronic record. For example, topology feature may be data representative of a component configuration, architecture indicating connections between several components, and/or an organization of information in an electronic record. In some embodiments, a topology-based filtering operation comprises identifying one or more other topology features from one or more archived project electronic records. In some embodiments, a topology-based filtering operation comprises comparing the topology feature with one or more of the one or more other topology features. In this regard, for example, the cloud-based project operations device 140 may identify an archived project electronic record by finding a match between the topology feature and the one or more of the one or more other topology features.

In some embodiments, the set of electronic filtering operations comprises a color-based filtering operation. In some embodiments, a color-based filtering operation comprises identifying first pixel data from a requirement electronic record. In some embodiments, a color-based filtering operation comprises identifying other pixel data from one or more archived project electronic records. For example, first pixel data and/or other pixel data may be representative of colors, color usage patterns, and/or color coordinates in an electronic record. In some embodiments, a color-based filtering operation comprises comparing the first pixel data with the other pixel data. In this regard, for example, the cloud-based project operations device 140 may identify an archived project electronic record by finding a match between the first pixel data and the other pixel data.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, requirement feature may be representative of a physical layout of a building in which the temperature is to be controlled (e.g., a constraint).

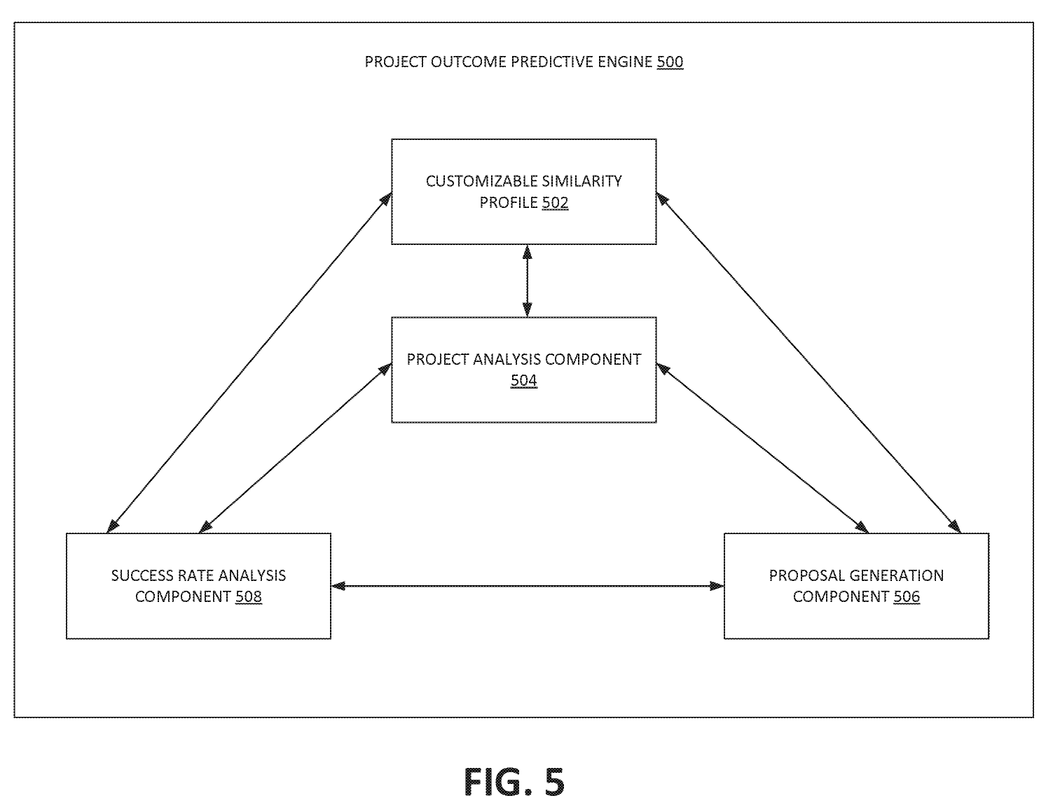

Referring now to FIG. 5, an example project outcome predictive engine 500 is illustrated. As depicted, project outcome predictive engine 500 includes a customizable similarity profile 502, project analysis component 504, proposal generation component 506, and success rate analysis component 508. Project outcome predictive engine 500 may be configured to predict success rates associated with project details, project proposals, and the like based on historical project data, a customizable similarity profile, and using one or more machine learning models.

A customizable similarity profile 502 may be utilized and edited either automatically and/or by a user, wherein the customizable similarity profile is configured to define a manner in which various project features are compared, quantified, and ultimately weighted as contributions to an overall similarity determination. For example, a project outcome predictive engine may be configured to process a plurality of historical projects to determine which features of the plurality of projects are most often shared by projects with a same (or similar) outcome. In other words, the project outcome predictive engine may be configured to (i) determine a plurality of subsets of historical projects, wherein each subset comprises projects which share a project outcome, and (ii) determine, relative to each subset, which project features are most commonly shared among the projects of the subset of historical projects. By determining which features are most commonly shared amongst subsets of historical projects which ultimately yielded a same outcome, the project outcome predictive engine can determine which features most commonly contribute to the shared outcome. For example, the project outcome predictive engine may determine that projects or project proposals comprising a first cost feature or projection (for example, a projected cost which is at least 5% under budget) exhibited a 90% success-rate. Further, the project outcome predictive engine may determine that projects or project proposals comprising a second cost feature or projection (for example, a projected cost which is at least 5% over budget) exhibited a 40% success-rate. As such, in a first embodiment corresponding to the aforementioned example subset success-rates, the project outcome predictive engine may be configured to determine that projected cost relative to a budget is a highly predictive feature, given that the exhibited success-rate of these subsets varies by 50%. In a second embodiment corresponding to the aforementioned example subset success-rates, the project outcome predictive engine may be configured to determine that the projected cost below an established budget is a feature that is highly correlated to winning proposals due to their 90% success rate, whereas projected cost above an established budget is a feature that is highly correlated to losing proposals due to their 40% success-rate. Customizable similarity profile 502 may be accessible to project analysis component 504 to inform feature weights and the like for project analysis operations. Customizable similarity profile 502 may be accessible to proposal generation component 506 to inform feature weights and the like for generating and/or updating a proposal. Customizable similarity profile 502 may be accessible to success rate analysis component 508 to inform feature weights and the like for success rate analysis.

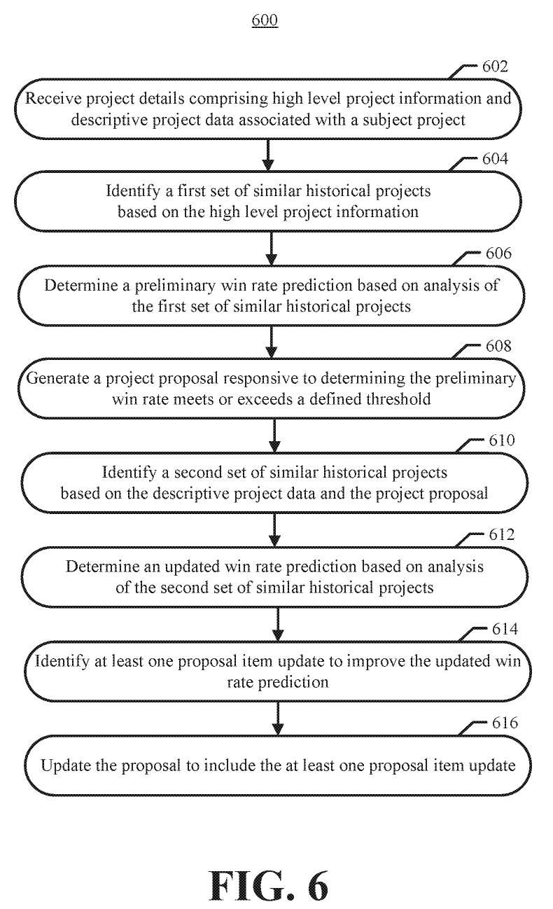

Project analysis component 504 may be configured for analyzing a subject project and/or one or more historical projects. In at least some embodiments, project analysis component 504 is configured for identifying a first set of similar historical projects based on high level project information, as described with respect to step 604 of FIG. 6. In at least some embodiments, project analysis component 504 is configured for identifying a second set of similar historical projects based on descriptive project data and a project proposal, as described with respect to step 610 of FIG. 6. In general, project analysis component 504 is configured to extract and/or analyze one or more features of a subject project, project proposal, historical project, or historical project proposal.

Proposal generation component 506 may be configured for generating a proposal subsequent to a determination of a preliminary success rate prediction that meets or exceeds a required threshold. In at least some embodiments, proposal generation component 506 is configured for generating a project proposal by generating a task plan for meeting requirements of the subject project, as described with respect to step 608 of FIG. 6. In at least some embodiments, proposal generation component 506 is configured for identifying at least one proposal item update to improve the updated success-rate prediction, as is described with respect to step 614 of FIG. 6. In at least some embodiments, proposal generation component 506 is configured for updating the proposal to include the at least one proposal item update, as is described with respect to step 616 of FIG. 6. In general, proposal generation component 506 is configured to generate complete project proposals corresponding to a subject proposal responsive to determining a project has an acceptable predicted success rate.

Success rate analysis component 508 may be configured for determining a predicted success rate associated with a subject project and/or project proposal. In at least some embodiments, success rate analysis component 508 is configured for determining a preliminary success-rate prediction based on analysis of the first set of similar historical projects, as is described with respect to step 606 of FIG. 6. In at least some embodiments, success rate analysis component 510 is configured for determining an updated success-rate prediction based on analysis of the second set of similar historical projects, as is described with respect to step 612 of FIG. 6.

### Example Methods

Referring now to FIG. 6, a flowchart providing an example method 600 is illustrated. In this regard, FIG. 6 illustrates operations that may be performed by the project foundation device 180, the external project implementation device 120, the external project application device 110, the cloud-based project operations device 140, the one or more databases 150, and/or the user device 170. In some embodiments, the method 600 comprises operations for adjusting a proposal based at least in part on a predicted success-rate. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As depicted, example method 600 includes receiving (602) project details associated with a subject project comprising high level project information and descriptive project data, identifying (604) a first set of similar historical projects based on the high level project information, determining (606) a preliminary success-rate prediction based on analysis of the first set of similar historical projects, generating (608) a project proposal responsive to determining the preliminary success-rate meets or exceeds a defined threshold, identifying (610) a second set of similar historical projects based on the descriptive project data and the project proposal, determining (612) an updated success-rate prediction based on analysis of the second set of similar historical projects, identifying (614) at least one proposal item update to improve the updated success-rate prediction, and updating (616) the proposal to include the at least one proposal item update. Example method 600 may provide a two-stage success-rate analysis with respect to a proposed project.

At step 602, a project outcome predictive engine receives project details associated with a subject project. Receiving (602) project details associated with a subject project comprising high level project information and descriptive project data may include receiving metadata associated with a project indicating high level project information (such as who the project is from/for, what field the project generally pertains to, one or more project contacts, and the like) and descriptive project data (such as budget information, timing information, required compliance information, and the like). In at least some embodiments, receiving (602) project details associated with a subject project includes receiving a document or other record describing project information, such as a set of project requirements, a set of project steps and a subset of the set of dependencies corresponding to each step of the set of project steps. For example, for a subject project step of the set of project steps, the project information may include one or more dependencies (required resources, services, and/or the like) required to complete the subject project step. In at least some embodiments, receiving (602) project details associated with a subject project includes receiving a project proposal associated with the subject project. A project proposal as described herein may include a document, record, or other data item that details a subject proposed project, the purpose of the subject project, how the subject project will be executed, and the expected outcomes of the subject project. An initially received project proposal may be relatively incomplete or detail-scarce, simply intended to provide necessary information for analysis without requiring a heavy resource load upfront. In at least some embodiments, a project proposal additionally includes a preliminary timeline for completion and/or projected budget information associated with costs to complete the project. In at least some embodiments, receiving (602) project details associated with a subject project includes receiving a project bid associated with the subject project. In at least some embodiments, a project bid is a formal proposal or estimate for completing a project contract. A project bid may outline a proposed cost, proposed timeline, and a proposed scope of work.

At step 604, the project outcome predictive engine identifies a first set of similar historical projects. Identifying (604) a first set of similar historical projects based on the high level project information may include comparing the high level project information of the subject project to high level information of one or more historical projects, available via a historical project database, for example. Identifying (604) a first set of similar historical projects may include analyzing a set of historical projects identify one or more historical projects which share a requisite number of pertinent features, requirements, and/or steps. In at least some embodiments, identifying (604) a first set of similar historical projects includes weighting each historical project of the first set of similar historical projects based, at least in part, on one or more similarity metrics. Generally, identifying (604) a first set of similar historical projects may include identifying projects which share one or more high level details, such as an associated contact or a general field associated with the project. In at least some embodiments, identifying (604) a first set of similar historical projects includes identifying projects which share one or more designated/selected/defined features. For example, in embodiments wherein a user is most interested in initially determining a success rate on the basis of an assigning authority (in other words, a success rate associated with a specific vendor/customer), the selected feature may be the issuing authority, and the project outcome predictive engine is configured to identify any projects which also share the same issuing authority. In at least some embodiments, the project outcome predictive engine may additionally be configured to analyze similarity between the other features of the plurality of historical projects to determine a similarity score with respect to the remaining (non-issuing authority) features. In such embodiments, the project outcome predictive engine may additionally be configured to identify a first set of similar historical projects which (i) include

At step 606, the project outcome predictive engine determines a preliminary success-rate prediction. Determining (606) a preliminary success-rate prediction based on analysis of the first set of similar historical projects may include determining a success-rate associated with the first set of similar historical projects. In at least some embodiments, determining (606) a preliminary success-rate prediction includes taking an average success-rate across the first set of similar historical projects. In at least some embodiments, determining (606) a preliminary success-rate prediction includes aggregating the weighted features of the subject project to determine a preliminary success-rate prediction. In at least some embodiments, determining (606) a preliminary success-rate prediction based on analysis of the first set of similar historical projects may include determining, based on the first set of similar historical projects, a threshold success score associated with the first set of similar historical projects. The threshold success score may be a score, determined according to an average, a minimum, or a mode value of an aggregation of the features of each historical project of a set of successful historical projects, configured to enable prediction of proposal success based at least in part on an average score, a minimum score, or mode score associated with successful projects. In at least some embodiments, determining (606) a preliminary success-rate prediction may include determining the preliminary success-rate prediction based on a comparison between an aggregation of the features of the subject project and the threshold success score.

At step 608, the project outcome predictive engine generates a project proposal responsive to determining the preliminary success-rate meets or exceeds a defined threshold. Generating (608) a project proposal may include generating a task plan for meeting the requirements of the subject project. Project proposals may include solicited proposals generated responsive to a request for proposal, unsolicited proposals in the absence of a request for proposal, renewal proposals for extending or otherwise re-implementing an existing proposal, continuation proposals configured to provide informational updates regarding an ongoing project, or supplemental proposals configured to add information to an existing proposal. In at least some embodiments, generating (608) a project proposal includes using generative AI techniques to generate an executive summary of a project problem and a proposed solution associated with the proposal. In at least some embodiments, generating (608) a project proposal includes defining deliverables associated with the proposal, according to which the project solution will be reached. In at least some embodiments, generating (608) a project proposal includes defining a set of required resources, and potentially a set of preferred vendors/resource providers via which the required resources may be acquired or otherwise made available.

At step 610, the project outcome predictive engine identifies a second set of similar historical projects. Identifying (610) a second set of similar historical projects based on the descriptive project data and the project proposal may include comparing the descriptive project data of the subject project to descriptive project data of one or more historical projects, available via a historical project database, for example. Generally, identifying (610) a second set of similar historical projects may include identifying projects which comprise substantively similar descriptive project data. In at least some embodiments, identifying (610) a second set of similar historical projects may include analyzing a plurality of historical projects according to one or more features and/or requirements as laid out by a customizable similarity profile.

A customizable similarity profile may be utilized and edited either automatically and/or by a user, wherein the customizable similarity profile is configured to define a manner in which various project features are compared, quantified, and ultimately weighted as contributions to an overall similarity determination. For example, a project outcome predictive engine may be configured to process a plurality of historical projects to determine which features of the plurality of projects are most often shared by projects with a same (or similar) outcome. In other words, the project outcome predictive engine may be configured to (i) determine a plurality of subsets of historical projects, wherein each subset comprises projects which share a project outcome, and (ii) determine, relative to each subset, which project features are most commonly shared among the projects of the subset of historical projects. By determining which features are most commonly shared amongst subsets of historical projects which ultimately yielded a same outcome, the project outcome predictive engine can determine which features most commonly contribute to the shared outcome. For example, the project outcome predictive engine may determine that projects or project proposals comprising a first cost feature or projection (for example, a projected cost which is at least 5% under budget) exhibited a 90% success-rate. Further, the project outcome predictive engine may determine that projects or project proposals comprising a second cost feature or projection (for example, a projected cost which is at least 5% over budget) exhibited a 40% success-rate. As such, in a first embodiment corresponding to the aforementioned example subset success-rates, the project outcome predictive engine may be configured to determine that projected cost relative to a budget is a highly predictive feature, given that the exhibited success-rate of these subsets varies by 50%. In a second embodiment corresponding to the aforementioned example subset success-rates, the project outcome predictive engine may be configured to determine that the projected cost below an established budget is a feature that is highly correlated to winning proposals due to their 90% success rate, whereas projected cost above an established budget is a feature that is highly correlated to losing proposals due to their 40% success-rate.

In at least some embodiments, the customizable similarity profile may be configured to identify features which are (i) heavily correlated (i.e., meet or exceed a defined threshold correlation) with a subset of winning proposals (also referred to as success-correlated, and flagged as such), (ii) heavily correlated (i.e., meet or exceed a defined threshold correlation) with a subset of losing proposals, and/or (iii) substantially different with respect to the subset of winning proposals and the set of losing proposals. A feature may be considered “substantially different” if a success-rate delta between a percentage of winning proposals which exhibit the subject feature and a percentage of losing proposals which exhibit the subject feature differ by at least a threshold percentage. In at least some embodiments, the customizable similarity profile includes weighting(s) for the features based on the correlations to winning proposals, losing proposals, and the success-rate delta. In at least some embodiments, the customizable similarity profile identifies one or more features as priority features.

At step 612, the project outcome predictive engine determines an updated success-rate prediction. Determining (612) an updated success-rate prediction based on analysis of the second set of similar historical projects may include using a trained machine learning model to predict a success rate of the generated proposal. In at least some embodiments, the trained machine learning model is trained according to the identified second set of similar historical projects. Determining (612) an updated success-rate prediction may include determining a success-rate associated with the second set of similar historical projects. In at least some embodiments, determining (612) an updated success-rate prediction includes taking an average success-rate across the second set of similar historical projects. In at least some embodiments, determining (612) an updated success-rate prediction includes aggregating the weighted features of the subject project to determine an updated feature score. In at least some embodiments, determining (612) an updated success-rate prediction based on analysis of the second set of similar historical projects may include determining, based on the second set of similar historical projects, an updated threshold success score associated with the second set of similar historical projects. The updated threshold success score may be a score, determined according to an average, a minimum, or a mode value of an aggregation of the features of each historical project of a set of successful historical projects, configured to enable prediction of proposal success based at least in part on an average score, a minimum score, or mode score associated with successful projects. In at least some embodiments, determining (612) an updated success-rate prediction may include determining the updated success-rate prediction based on a comparison between an aggregation of the features of the subject project proposal and the updated threshold success score.

At step 614, the project outcome predictive engine identifies at least one proposal item update to improve the updated win prediction. Identifying (614) at least one proposal item update to improve the updated success-rate prediction may include identifying proposal items in the generated proposal which differ from corresponding items in one or more successful projects of the second set of similar historical projects. In at least some embodiments, identifying (614) at least one proposal item update includes identifying one or more features identified by the customizable similarity profile which are deficient with respect to the analysis of successful historical projects/project proposals. In at least some embodiments, identifying (614) at least one proposal item update to improve the updated success-rate prediction includes generating a project update which improves the updated success-rate prediction without exceeding one or more project restrictions. For example, in an embodiment where a completion date is identified as an area of potential improvement, the project outcome predictive engine may be configured to analyze costs associated with expediting processes to improve the completion date and compare said costs to an allowable cost threshold. In at least some embodiments, identifying (614) at least one proposal item update includes, responsive to determining the project limitation impact exceeds an acceptable threshold, generating a substitute proposal item update to improve the updated success-rate prediction. In general, identifying (614) at least one proposal item update includes identifying ways via which the success rate of the subject proposal can be improved based on analysis of the historical projects in light of one or more project limitations.

At step 616, the project outcome predictive engine updates the proposal to include the at least one proposal item update. Updating (616) the proposal to include the at least one proposal item update may include generating an updated proposal which incorporates the at least one proposal item update, in some cases in place of a previously existing corresponding proposal item. In at least some embodiments, updating (616) the proposal to include the at least one proposal item update includes adding an item to the proposal to reflect an addition corresponding to the at least one proposal item update. In at least some embodiments, updating (616) the proposal to include the at least one proposal item update includes instead updating the proposal to include the substitute proposal item update.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A computer-implemented method comprising:
receiving, by one or more processors, a set of project information comprising high-level project data and descriptive project data associated with a subject project;
identifying, by the one or more processors, a first set of similar historical projects based on the high-level project data;
determining, by the one or more processors and using a trained prediction model, a preliminary success-rate prediction based on analysis of the first set of similar historical projects;
generating, by the one or more processors, a project proposal responsive to determining that the preliminary success-rate prediction meets or exceeds a defined threshold;
identifying, by the one or more processors, a second set of similar historical projects based on the descriptive project data and the project proposal;
determining, by the one or more processors and using the trained prediction model updated based on the second set of similar historical projects, an updated success-rate prediction;
generating, by the one or more processors, at least one proposal item update to improve the updated success-rate prediction; and
generating, by the one or more processors, an updated proposal according to the at least one proposal item update.

2. The computer-implemented method of claim 1, further comprising:
generating, by the one or more processors, a customizable similarity profile configured to define one or more metrics according to which the first set of similar historical projects or the second set of similar historical projects are determined.

3. The computer-implemented method of claim 2, wherein the customizable similarity profile defines one or more feature weights corresponding to one or more features, wherein the first set of similar historical projects or the second set of similar historical projects are determined according to the one or more feature weights.

4. The computer-implemented method of claim 3, wherein the customizable similarity profile defines a first priority feature of the one or more features according to which the first set of similar historical projects are determined.

5. The computer-implemented method of claim 3, further comprising:
determining, by the one or more processors, a success-rate correlation between a first feature of the one or more features and a subset of winning projects of the first set of similar historical projects.

6. The computer-implemented method of claim 5, further comprising:
determining, by the one or more processors, a success-rate delta for a subject feature of the one or more features between a percentage of successful proposals which exhibit the subject feature and a percentage of losing proposals which exhibit the subject feature; and
responsive to determining that the success-rate delta exceeds a defined threshold, flagging, by the one or more processors, the subject feature as a success-correlated feature.

7. The computer-implemented method of claim 1, further comprising:
determining, by the one or more processors, a project limitation impact associated with the at least one proposal item update; and
responsive to determining the project limitation impact exceeds an acceptable threshold, generating, by the one or more processors, a substitute proposal item update to improve the updated success-rate prediction.

8. An apparatus comprising memory and one or more processors communicatively coupled to the memory, the one or more processors configured to perform operations comprising:
receiving a set of project information comprising high-level project data and descriptive project data associated with a subject project;
identifying a first set of similar historical projects based on the high-level project data;
determining, using a trained prediction model, a preliminary success-rate prediction based on analysis of the first set of similar historical projects;
generating a project proposal responsive to determining that the preliminary success-rate prediction meets or exceeds a defined threshold;
identifying a second set of similar historical projects based on the descriptive project data and the project proposal;
determining, using the trained prediction model updated based on the second set of similar historical projects, an updated success-rate prediction;
generating at least one proposal item update to improve the updated success-rate prediction; and
generating an updated proposal according to the at least one proposal item update.

9. The apparatus of claim 8, the operations further comprising:
generating a customizable similarity profile configured to define one or more metrics according to which the first set of similar historical projects or the second set of similar historical projects are determined.

10. The apparatus of claim 9, wherein the customizable similarity profile defines one or more feature weights corresponding to one or more features, wherein the first set of similar historical projects or the second set of similar historical projects are determined according to the one or more feature weights.

11. The apparatus of claim 10, wherein the customizable similarity profile defines a first priority feature of the one or more features according to which the first set of similar historical projects are determined.

12. The apparatus of claim 10, the operations further comprising:
determining a success-rate correlation between a first feature of the one or more features and a subset of winning projects of the first set of similar historical projects.

13. The apparatus of claim 12, the operations further comprising:
determining a success-rate delta for a subject feature of the one or more features between a percentage of successful proposals which exhibit the subject feature and a percentage of losing proposals which exhibit the subject feature; and
responsive to determining that the success-rate delta exceeds a defined threshold, flagging the subject feature as a success-correlated feature.

14. The apparatus of claim 8, the operations further comprising:
determining a project limitation impact associated with the at least one proposal item update; and
responsive to determining the project limitation impact exceeds an acceptable threshold, generating a substitute proposal item update to improve the updated success-rate prediction.

15. A computer program product comprising at least one non-transitory computer-readable storage medium having computer program code stored thereon that, in execution with at least one processor, configures the computer program product for:
receiving a set of project information comprising high-level project data and descriptive project data associated with a subject project;
identifying a first set of similar historical projects based on the high-level project data;
determining, using a trained prediction model, a preliminary success-rate prediction based on analysis of the first set of similar historical projects;
generating a project proposal responsive to determining that the preliminary success-rate prediction meets or exceeds a defined threshold;
identifying a second set of similar historical projects based on the descriptive project data and the project proposal;
determining, using the trained prediction model updated based on the second set of similar historical projects, an updated success-rate prediction;
generating at least one proposal item update to improve the updated success-rate prediction; and
generating an updated proposal according to the at least one proposal item update.

16. The computer program product of claim 15, the at least one non-transitory computer-readable storage medium having computer program code stored thereon that, in execution with at least one processor, further configures the computer program product for:
generating a customizable similarity profile configured to define one or more metrics according to which the first set of similar historical projects or the second set of similar historical projects are determined.

17. The computer program product of claim 16, wherein the customizable similarity profile defines one or more feature weights corresponding to one or more features, wherein the first set of similar historical projects or the second set of similar historical projects are determined according to the one or more feature weights.

18. The computer program product of claim 17, the at least one non-transitory computer-readable storage medium having computer program code stored thereon that, in execution with at least one processor, further configures the computer program product for:
determining a success-rate correlation between a first feature of the one or more features and a subset of winning projects of the first set of similar historical projects.

19. The computer program product of claim 18, the at least one non-transitory computer-readable storage medium having computer program code stored thereon that, in execution with at least one processor, further configures the computer program product for:
determining a success-rate delta for a subject feature of the one or more features between a percentage of successful proposals which exhibit the subject feature and a percentage of losing proposals which exhibit the subject feature; and
responsive to determining that the success-rate delta exceeds a defined threshold, flagging the subject feature as a success-correlated feature.

20. The computer program product of claim 15, the at least one non-transitory computer-readable storage medium having computer program code stored thereon that, in execution with at least one processor, further configures the computer program product for:
determining a project limitation impact associated with the at least one proposal item update; and
responsive to determining the project limitation impact exceeds an acceptable threshold, generating a substitute proposal item update to improve the updated success-rate prediction.
